(19) United States
(12) Patent Application Publication
(10) Pub. No.: US 2016/0132975 A1
(43) Pub. Date: May 12, 2016

(54) IDENTIFYING HIGH USAGE PERIODS

(71) Applicant: Opower, Inc., Arlington, VA (US)

(72) Inventors: Stephanie Liao, San Francisco, CA (US); Jacqueline Chiu, San Francisco, CA (US); Dean Allen, San Francisco, CA (US); Patrick Harazin, San Francisco, CA (US); Brian Sloss, San Francisco, CA (US); Koorosh Nouri, San Francisco, CA (US)

(21) Appl. No.: 14/677,792

(22) Filed: Apr. 2, 2015

Related U.S. Application Data
(60) Provisional application No. 62/076,785, filed on Nov. 7, 2014.

(51) Int. Cl. G06Q 50/06; G06Q 30/02

(52) U.S. Cl. CPC G06Q 50/06; G06Q 30/0202

(57) ABSTRACT

Methods and systems for identifying high usage periods are provided herein. In one embodiment, a computer-implemented method comprises obtaining usage data covering a period of time, wherein the usage data comprises a plurality of usage values, each usage value indicating an amount of a commodity consumed over a respective time interval. The method also comprises grouping the usage values into a plurality of groups, wherein each group corresponds to a different time period, and, for each group, computing usage for the group based on the usage values in the group. The method further comprises identifying a group from the plurality of groups having a largest computed usage.

### CROSS-REFERENCE TO RELATED APPLICATIONS

The present application claims the benefit of priority to U.S. Provisional Application Ser. No. 62/076,785, filed Nov. 7, 2014, entitled “IDENTIFYING HIGH USAGE PERIODS,” which is hereby incorporated by reference in its entirety.

### BACKGROUND

The subject technology relates to processing usage data and in particular, to methods and systems for identifying high usage periods.

Unexpectedly high utility bills can have several ill effects including increased customer churn (in competitive markets), increased call volume, and increased late or partial payments, especially for customers on limited or fixed incomes. Utilities spend a large amount of money to support inbound calls/complaints associated with high utility bills. Many of these calls are caused by the shock that customers experience when they receive bills that are higher than expected. This high volume of inbound calls/complaints can cause a decrease in operational efficiency, resulting in long wait times for customers, thereby exasperating customer dissatisfaction.

### SUMMARY

According to various aspects of the subject technology, systems and methods for identifying high usage periods are described.

In one aspect, a computer-implemented method is provided. The method comprises obtaining usage data covering a period of time, wherein the usage data comprises a plurality of usage values, each usage value indicating an amount of a commodity consumed over a respective time interval. The commodity may comprise electricity, water, gas, or other consumable resource. The method also comprises grouping the usage values into a plurality of groups, wherein each group corresponds to a different time period, and, for each group, computing usage for the group based on the usage values in the group. The method further comprises identifying a group from the plurality of groups having a largest computed usage.

A second aspect relates to a system. The system comprises a computer processor, and a memory storing instructions. The instructions, when executed, cause the computer processor to obtain usage data covering a period of time, wherein the usage data comprises a plurality of usage values, each usage value indicating an amount of a commodity consumed over a respective time interval. The instructions, when executed, also cause the computer processor to group the usage values into a plurality of groups, wherein each group corresponds to a different time period, and, for each group, compute usage for the group based on the usage values in the group. The instructions, when executed, further cause the computer processor to identify a group from the plurality of groups having a largest computed usage.

A third aspect relates to a non-transitory computer-readable medium storing instructions. The instructions, when executed by a computer processor, cause the computer processor to obtain usage data covering a period of time, wherein the usage data comprises a plurality of usage values, each usage value indicating an amount of a commodity consumed over a respective time interval. The instructions, when executed by the computer processor, also cause the computer processor to group the usage values into a plurality of groups, wherein each group corresponds to a different time period, and, for each group, compute usage for the group based on the usage values in the group. The instructions, when executed by the computer processor, further cause the computer processor to identify a group from the plurality of groups having a largest computed usage.

### BRIEF DESCRIPTION OF THE DRAWINGS

In the following description, reference is made to the following figures, and in which are shown by way of illustration specific embodiments in which the subject technology may be practiced. It is to be understood that other embodiments may be utilized and changes may be made without departing from the scope of the subject technology.

FIG. 1 illustrates an example of an environment in which aspects of the subject technology may be implemented.

FIG. 2 shows an example of a high-bill alert notification according to certain aspects of the subject technology.

FIG. 3 shows an example of a high usage period notification according to certain aspects of the subject technology.

FIG. 4 is a timeline showing an example of grouping usage values into groups according to certain aspects of the subject technology.

FIG. 5 is a flowchart illustrating a method for processing usage data according to certain aspects of the subject technology.

FIG. 6 is a flowchart illustrating another method for processing usage data according to certain aspects of the subject technology.

FIG. 7 is a flowchart illustrating yet another method for processing usage data according to certain aspects of the subject technology.

FIG. 8 shows an example of a system according to certain aspects of the subject technology.

FIG. 9 illustrates an example of a usage alert notification according to certain aspects of the subject technology.

FIG. 10 illustrates an example of an environment for implementing various embodiments of the subject technology.

FIG. 11 illustrates a system for usage alerts according to certain aspects of the subject technology.

FIG. 12 illustrates an example configuration of components of a computing device according to aspects of the subject technology.

FIG. 13 illustrates an electronic system with which features of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Unexpectedly high utility bills can have several ill effects including increased customer churn (in competitive markets), increased call volume, and increased late or partial payments, especially for customers on limited or fixed incomes. Utilities spend a large amount of money to support inbound calls/complaints associated with high utility bills. Many of these calls are caused by the shock that customers experience when they receive bills that are higher than expected. This high volume of inbound calls/complaints can cause a decrease in operational efficiency, resulting in long wait times for customers, thereby exasperating customer dissatisfaction.

One approach to mitigate this problem is to forecast (project) a customer's utility bill before the end of a billing period based on customer usage data, determine whether the forecasted bill is unexpectedly high, and send a high-bill alert notification to the customer if the forecasted bill is unexpectedly high to notify the customer that he/she is on track to receive an unexpectedly high bill. The alert notification gives the customer an opportunity to change his/her behavior in the time remaining in the current billing period to reduce the actual utility bill. However, a high-bill alert notification alone may not provide the customer with enough information to determine what is causing the forecasted bill to be unexpectedly high, and therefore to determine how to effectively change his/her behavior to reduce the utility bill.

Aspects of the subject technology address the foregoing problem by providing a High Usage Period (HUP) notification (e.g., with a high-bill alert notification) to a customer when the customer is on track to receive an unexpectedly high utility bill. In one embodiment, the HUP notification divides the time of day into different time periods (blocks), shows the customer's usage of a commodity (e.g., electricity, gas, water) for each time period (block), and highlights the time period with the highest usage. By highlighting the time period with the highest usage, the HUP notification allows the customer to make a connection between his/her behavior during that time period and high usage. This connection allows the customer to focus on changing behavior that is more likely to have a large impact on his/her usage, and hence his/her utility bill. As a result, the customer can more effectively reduce his/her utility bill.

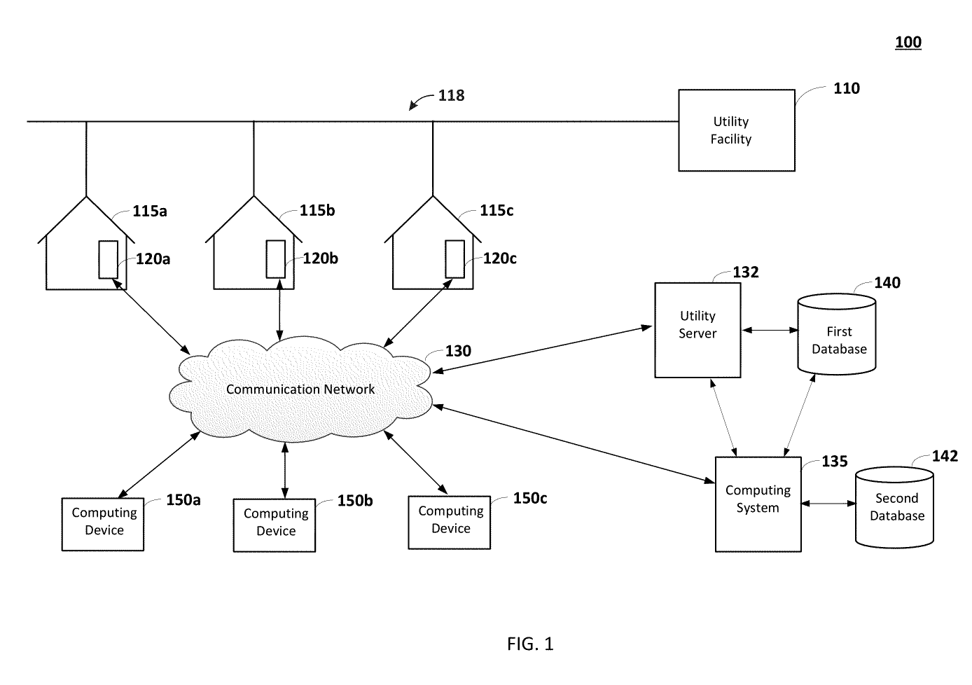

Before discussing various embodiments of the subject technology in more detail, it may be useful to describe an exemplary environment in which various aspects of the subject technology may be implemented. In this regard, FIG. 1 shows an exemplary environment 100 including a utility facility 110 that provides a commodity (e.g., electricity, gas, water) to a plurality of properties 115a-115c (e.g., residential homes, apartments, commercial buildings, etc.) over a geographical area. Each property 115a-115c may be associated with a utility customer responsible for paying the utility company for the amount of the commodity used (consumed) at the property. The term “commodity” described herein refers to a utility-based commodity, such as electricity, water, and natural gas, which are consumable finite resources delivered to a property (e.g., dwelling, commercial structure, etc.). Although three properties 115a-115c are shown in FIG. 1 for ease of illustration, it is to be appreciated that the environment 100 may include a much larger number of properties.

The utility facility 110 provides the commodity to the properties 115a-115c via a distribution network 118. For the example in which the commodity is electricity, the distribution network 118 may comprise an electrical grid that distributes electricity from an electric generator at the utility facility 110 to the properties 115a-115c. For the example in which the resource is natural gas, the distribution network 118 may comprise a network of pipes that distribute gas from a storage facility at the utility facility 110 to the properties 115a-115c.

In the example in FIG. 1, the environment 100 includes a monitoring device 120a-120c at each property. Each monitoring device 120a-120b may comprise an electronic device (e.g., a metering device) configured to monitor the amount of the utility-based commodity used (consumed) at the respective property (e.g., a smart meter may measure consumed commodities in intervals of an hour or less), and to communicate corresponding usage data to a utility server 132 via a communication network 130 for monitoring and billing purposes. The communication network 130 may comprise an existing cellular network, a dedicated wireless network (e.g., a smart grid), a wide area network (WAN), other type of network, or a combination thereof. Upon receiving usage data from a monitoring device 120a-120c, the utility server 132 stores the usage data in a first database 140, in which the stored usage data may be associated with a utility account of the utility customer residing at the respective property. For each utility customer, the first database 140 may store past usage data for one or more completed billing periods, and usage data for a completed portion of the current billing period. The first database 140 may also store billing information for customers including utility rates, billing statements, customer contact information (e.g., electronic mail addresses, physical addresses, phone numbers, etc.). It is to be appreciated that the utility server 132 in FIG. 1 may represent a single computing system or a plurality of interconnected computing systems that perform one or more of the functions described herein. It is also to be appreciated that the first database 140 may represent one or more databases.

The environment 100 may also comprise one or more computing devices 150a-150c for each of the utility customers associated with the properties 115a-115c. The computing devices may also be referred to as client devices, user devices or other terminology. A computing device may comprise a mobile device (e.g., mobile phone), a computer, a laptop, and/or a tablet of the respective utility customer. A computing device may also comprise a climate control device (e.g., smart thermostat), a set-top box, a phone, a voicemail box, a gaming console, a smart television or other smart appliance, that is able to receive information (e.g., set point) over the communication network, and provide the information to the respective customer. In this example, the utility server 132 may communicate information (e.g., utility bill, a home energy report, a high-bill alert notification, and/or a High Usage Period notification) to a utility customer by sending the information to the respective computing device 150a-150c via the communication network 130. In this regard, the communication network 130 may comprise a cellular network, the Internet, other type of network, or a combination thereof. The information may be sent in the form of a text message (e.g., short message service (SMS) message), an email, an automated voice message, etc. Upon receiving the information, the computing device may provide the information to the respective customer using a mobile application, a text-message application, an electronic-mail application, etc. It is to be appreciated that the communication network 130 in FIG. 1 may represent one or more networks.

The environment 100 may also comprise a computing system 135 configured to communicate with the utility server 132 and/or the first database 140 (e.g., via a wired connection, a wireless connection, a network, etc.). The computing system 135 may be configured to generate High Usage Period (HUP) notifications according to embodiments of the present disclosure, discussed further below. In this regard, the computing system 135 may retrieve information from the first database 140 needed to generate HUP notifications and/or any other information (e.g., customer contact information) needed to perform operations described herein, and store the retrieved information in a second database 142. The computing system 135 may retrieve the information directly from the first database 140 (e.g., if the computing system 135 is granted direct access to the first database 140). Alternatively, the computing system 135 may request information from the utility server 132. In response, the utility server 132 may retrieve the information from the first database 140, and forward the retrieved information to the computing system 135. As discussed above, the first database 140 may represent multiple databases (e.g., usage database, billing database, etc.). In this example, the computing system 135 may include a data integrator configured to retrieve information from databases that the computing system 135 needs to perform operations described herein, and store the retrieved information in the second database 142 (e.g., consolidate the information in the second database 142) for use by the computing system 135.

To generate a HUP notification for a particular utility customer, the computing system 135 may retrieve usage data for the customer from the second database 142 and generate the HUP notification based on the usage data, as described further below. After generating the HUP notification, the computing system 135 may store the HUP notification in the second database 142. The computing system 135 may also send the HUP notification to the respective computing device 150a-150c via the communication network 130. To do this, the computing system 135 may retrieve customer contact information from the second database 142, and use the customer contact information to direct the HUP notification to the appropriate computing device, home address, etc. The HUP notification may be sent in the form of a text message (e.g., short message service (SMS) message), an email, an automated voice message, etc. The HUP notification may be included (e.g., embedded) in a high-bill alert notification, as described further below. In another aspect, the computing system 135 may send the HUP notification to the utility server 132 for the utility server 132 to send to the corresponding customer. In one embodiment, the utility server 132 may be operated by a utility company and the computing system 135 may be operated by a third party service provider that is interfaced with the utility company. The computing system 135 in FIG. 1 may represent a single computing system or a plurality of interconnected computing systems that perform one or more of the functions described.

During each billing period (e.g., month), the utility server 132 may retrieve usage data for a utility customer from the first database 140, in which the retrieved usage data spans the billing period (i.e., indicates the amount of the utility-based commodity used (consumed) at the respective property during the billing period). The utility server 132 may then generate a utility bill for the billing period based on the usage data and one or more applicable commodity rates (e.g., cost per unit of the commodity). After generating the utility bill, the utility server 132 may send the utility bill to the respective utility customer. For example, the utility server 132 may send the utility bill to the computing device of the customer for display to the customer in the form of an electronic mail, a text message, etc. (e.g., for a customer enrolled in electronic billing). In another embodiment, the utility server 132 may send the utility bill to the respective utility customer in the form of a hard copy via regular mail. The utility server 132 may also store the utility bill in the first database 140.

As discussed above, a high-bill alert notification may be sent to a customer before the end of the current billing period if the customer is on track to receive a high bill. In this regard, the computing system 135 may determine whether a customer is on track to receive a high bill before the end of the current billing period. The computing system 135 may do this by retrieving usage data and/or billing information (e.g., commodity rate) from the second database 142, in which the usage data and/or billing information was previously retrieved from the first database 140 and stored in the second database 142, as discussed above. Using the retrieved usage data and/or billing information, the computing system 135 may forecast (project) the customer's utility bill for the current billing period based on the amount of the commodity already used (consumed) by the customer in the completed portion of the current billing period, and a projection of the amount of the commodity that the customer will use (consume) in the remaining portion of the current billing period. The computing system 135 may estimate the amount of the commodity that the customer will use in the remaining portion of the billing period using any one of a number of techniques. For example, the computing system 135 may compute a rate of use based on the customer's usage over a time window (e.g., past seven days) and apply the computed rate of use to the time remaining in the current billing period. Examples of techniques for bill forecasting are discussed further below.

The computing system 135 may then compare the forecasted bill to a threshold. The threshold may be set to an amount equal to a certain percentage (e.g., 30%) above a previous utility bill of the customer, or other amount. If the forecasted bill is above the threshold, then the computing system 135 may determine that the customer is on track to receive a high bill, and generate a high-bill alert notification for the customer. The computing system 135 may send the high-bill alert notification to the customer via electronic mail, text message, automated call, etc. Alternatively, the computing system 135 may send the high-bill alert notification to the utility server 132 for the utility server 132 to send to the customer.

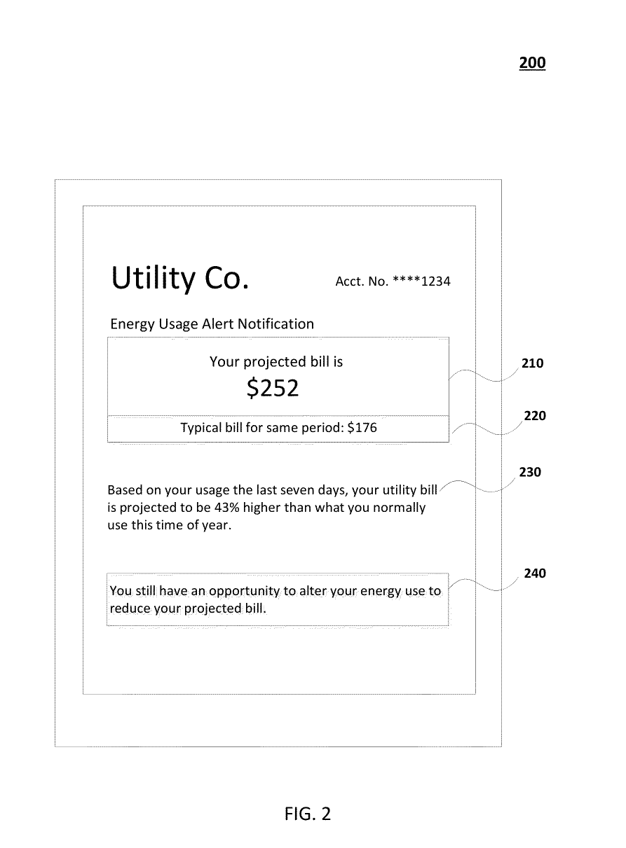

FIG. 2 shows an example of a high-bill alert notification 200 according to certain aspects of the subject technology. In this example, the high-bill alert notification 200 shows the amount of the customer's forecasted (projected) utility bill 210 for the current period, and the amount of the customer's previous bill 220 for the same period in the previous year for comparison. In this example, the forecasted (projected) bill is $252 and the previous bill for the same period in the previous year is $176. The high-bill alert notification 200 also includes a report analysis 230 comparing the forecasted bill to the previous bill. In this example, the report analysis 230 shows the percentage (e.g., 43%) over which the forecasted bill exceeds the previous bill. The high-bill alert notification 240 also includes a report message 240 notifying the customer that he/she still has an opportunity to reduce the actual bill at the end of the current billing period by altering his/her usage in the time remaining in the current billing period. The high-bill alert notification 200 may include additional information, as discussed further below.

By sending customers high-bill alert notifications when they are on track to receive unexpectedly high bills, the volume of inbound calls/complaints concerning high bills is reduced. This is because a high-bill alert notification makes it less likely that the respective customer will be surprised (shocked) by a high bill at the end of the current billing period, and therefore less likely that the customer will call to complain about the bill. In addition, the high-bill alert notification gives the customer an opportunity to change his/her behavior in the time remaining in the current billing period to reduce the actual utility bill. However, the high-bill alert notification alone may not provide the customer with enough information to determine what is causing the forecasted bill to be unexpectedly high. As a result, although the high-bill alert notification gives the customer an opportunity to change his/her behavior in time to reduce the bill, the notification may not provide the customer with enough information to determine how to effectively change his/her behavior to reduce the utility bill.

Embodiments of the subject technology address the foregoing problem by providing a High Usage Period (HUP) notification (e.g., with a high-bill alert notification) to a customer when the customer is on track to receive an unexpectedly high utility bill. In one embodiment, the HUP notification divides the time of day into different time periods (blocks), shows the customer's usage of the commodity (e.g., electricity, gas, water) for each time period (block), and highlights the time period with the highest usage. By highlighting the time period with the highest usage, the HUP notification allows the customer to make a connection between his/her behavior during that time period and high usage. This connection allows the customer to focus on changing behavior that is more likely to have a large impact on his/her usage, and hence his/her utility bill.

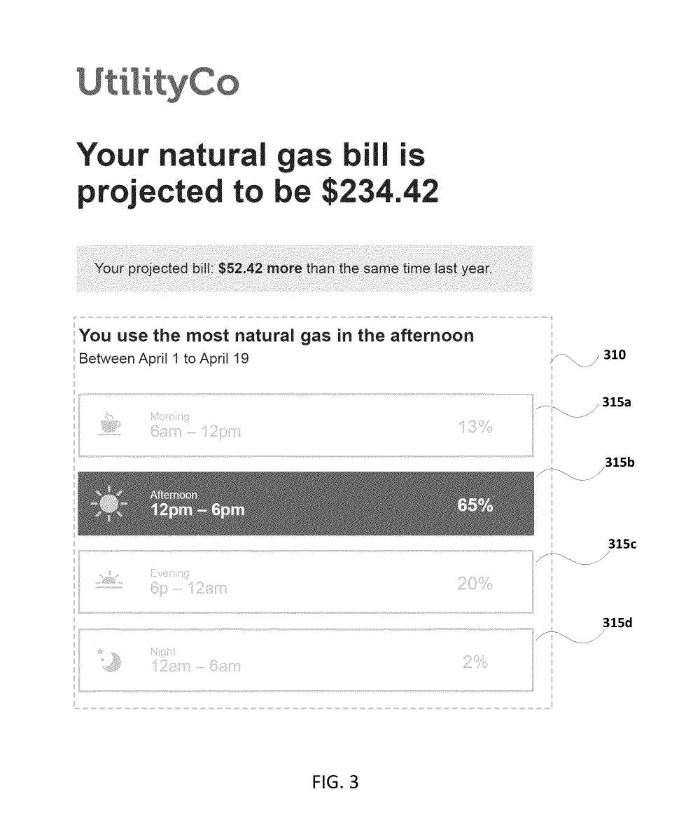

FIG. 3 shows an example of a HUP notification 310 according to certain embodiments of the subject technology. In this example, the HUP notification 310 is included with a high-bill alert notification. The HUP notification 310 divides the time of day into a plurality of time periods (blocks) 315a-315d, and shows the customer usage of the commodity (e.g., electricity, gas, water) for each time period. In this example, the HUP notification 310 divides the time of day into four time periods (i.e., 6 am-12 pm period 315a, 12 pm-6 pm period 315b, 6 pm-12 am period 315c, and 12 am-6 am period 315d). However, it is to be appreciated that the subject technology is not limited to this example and that the HUP notification may divide the time of day into any number of time periods. In this example, the time periods 315a-315d correspond to different parts of the day (morning, afternoon, evening and night) during which the customer may engage in different types of behavior affecting usage. For example, the customer may run an air conditioning system higher in the afternoon, run a heating system higher in the night, etc. Also, the customer may have a daily routine of engaging in certain behavior (e.g., running a dish washer, running a clothes washer, bathing, cooking, etc.) during certain parts of the day.

In the example in FIG. 3, the HUP notification 300 shows a percentage of the customer's total utility usage for each time period 315a-315d, and highlights the time period 315d with the highest usage. In this example, the time period 315b (12 pm-6 pm period) has the highest usage at 65% of the customer's total usage. Also, in this example, time period 315b is highlighted by making the text associated with time period 315b darker than the text associated with the other time periods, and shading the box associated with time period 315b. It is to be appreciated that time period 315b may be highlighted (emphasized) using other techniques.

By highlighting the time period with the highest usage, the HUP notification 310 prompts the customer to think about the types of behavior he/she engages in during the highlighted time period, and therefore determine what types of behavior may be driving the high usage. This insight allows the customer to focus on changing behavior that is more likely to have a larger impact on usage, and therefore more effectively reduce the actual bill at the end of the billing period.

Methods for generating a HUP notification will now be described according to various embodiments of the subject technology.

In one embodiment, the computing system 135 may generate a HUP notification for a utility customer by retrieving usage data from the second database 142 for the customer, in which the usage data covers a certain period of time. For example, the period of time may cover the past N days from the time of the most recent usage report from the corresponding monitoring device, where N may be an integer (e.g., integer between three and fifteen). In another example, the period of time may span the start of the current billing period to the time of the most recent usage report from the corresponding monitoring device (e.g., completed portion of the current billing period). In this regard, the completed portion of the current billing period may be 50% or less of the current billing period so that the HUP notification is provided to the customer in sufficient time to have an impact on his/her bill at the end of the billing period.

The retrieved usage data may comprise a plurality of usage values, in which each usage value provides the amount of the commodity used (consumed) over a short time interval (e.g., one hour or less). For example, the corresponding monitoring device (e.g., smart meter) may report one or more usage values to the utility server 132 on a periodic or scheduled basis, in which each usage value corresponds to a short time interval (e.g., time interval of an hour or less). The utility server 132 may store the received usage values in the first database 140, which the computing system 135 may then retrieve and store in the second database 142, as discussed above. For the example in which the commodity is electricity, a usage value may be given in units of kilowatt hours (kWh) or other units. A usage value may also be referred to as a usage read or meter read from the corresponding monitoring device. Accordingly, it is to be appreciated that embodiments of the subject technology are not limited to the particular terminology used herein.

For each usage value, the utility server 132 may store time information indicating the day and time interval associated with the usage value. For example, for a usage value providing the amount of the commodity used (consumed) from 2 pm to 2:15 pm on a particular day, the time information for the usage value may indicate the particular day and a time interval of 2 pm to 2:15 pm. Although, the length of a time interval is 15 minutes in the above example, it is to be appreciated that the length of a time interval may be shorter or longer than 15 minutes.

After retrieving the usage data for the period of time (e.g., past N days), the computing system 135 may group each of the corresponding usage values into one of a plurality of groups. Each group corresponds to a different time period, where each time period may be a different time-of-day period (e.g., 12 pm to 6 pm). Using the example in FIG. 3, there may be four groups, where each group corresponds to a different one of the time periods 315a-315d. For example, usage values having time intervals falling between 12 pm and 6 pm would be grouped into the group corresponding to time period 315b (12 pm-6 pm period). For instance, a usage value having a time interval of 2 pm to 2:15 pm would be grouped into time period 315b (12 pm-6 pm period).

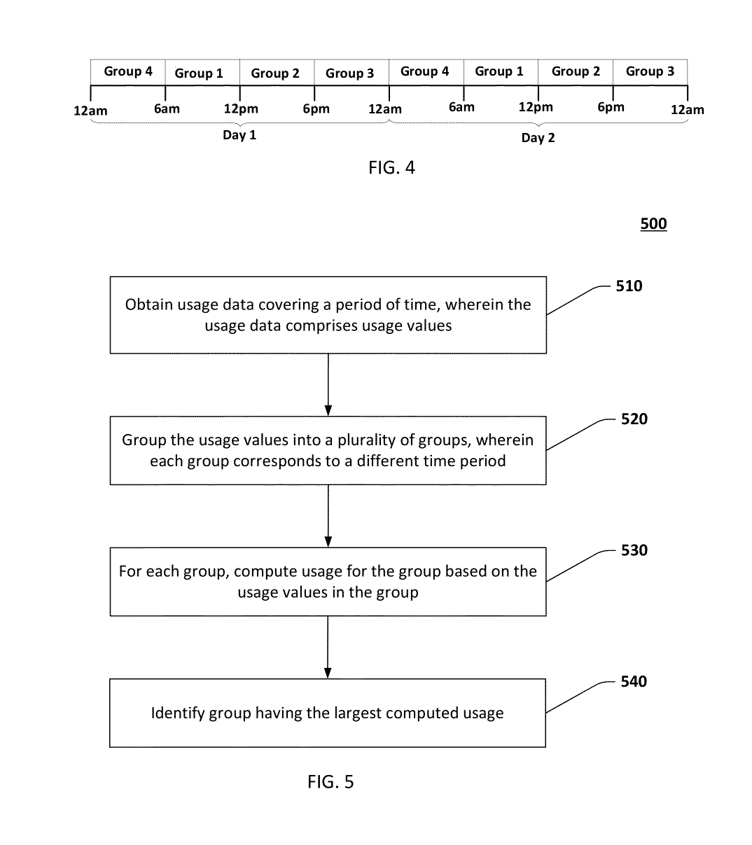

FIG. 4 is a timeline showing an example in which usage values for two days (denoted “Day 1” and “Day 2”) are grouped into four groups (denoted “Group 1,” “Group 2,” “Group 3,” and “Group 4”). In this example, Group 1 corresponds to time period 315a (6 am-12 pm period), Group 2 corresponds to time period 315b (12 pm-6 pm period), Group 3 corresponds to time period 315c (6 pm-12 am period), and Group 4 corresponds to time period 315d (12 am-6 am period). In this example, usage values for Day 1 and Day 2 having time intervals falling between 6 am and 12 pm are grouped into Group 1, as shown in FIG. 4. It is to be appreciated that only two days are shown in FIG. 4 for ease of illustration, and that the number of days covered by the HUP notification may be more than two days.

After grouping the usage values into the different groups, the computing system 135 may compute the usage for each group by summing the usage values in each group. The computing system 135 may also compute the total usage for all of the groups by summing all of the usage values in all of the groups. For each group, the computing system 135 may then compute a percentage of the total usage contributed by the group based on the computed usage for the group and the computed total usage. The percentage for each group (and hence each time period) may be displayed in the HUP notification, an example of which is shown in FIG. 3. The computing system 135 may also identify the group (time period) with the largest computed usage, and highlight the identified group (time period) in the HUP notification. In the example in FIG. 3, time period 315b has the highest usage, and is therefore highlighted.

FIG. 5 is a flowchart illustrating a method 500 for processing usage data according to certain embodiments of the subject technology. The method 500 may be performed by the computing system 135. The method 500 is provided merely as an example and additional or fewer steps may be performed in similar or alternative orders, or in parallel.

In step 510, usage data covering a period of time is obtained. The usage data may comprise usage values, where each usage value corresponds to an amount of the commodity (e.g., electricity, gas, water) used (consumed) over a short time interval (e.g., interval of an hour or less). The period of time may cover the past N days, where N may be an integer. In another example, the period of time may be a completed portion of the current billing period. The usage data may be obtained at a time when 50% or more of the current billing period still remains.

In step 520, the usage values are grouped into a plurality of groups, wherein each group corresponds to a different time period. For example, each time period may correspond to a different time-of-day period, such as different hours of the day.

In step 530, for each group, usage is computed for the group based on the usage values in the group. For example, usage may be computed for a group by summing the usage values in the group.

In step 540, the group with the highest computed usage is identified. In one aspect, the time period corresponding to the identified group may be highlighted in a HUP notification to indicate to the respective customer the time period in which he/she uses (consumes) the most resources.

In some cases, the usage data retrieved for a specific period of time may be incomplete. For example, the corresponding monitoring device may fail to report usage at certain times due to disruptions in the communication link between the monitoring device and the utility server 132, an error in the monitoring device, etc. In another example, the computing system 135 may not have access to all of the usage data for the period of time stored in the first database 140. In this example, the computing system 135 may have restricted access to the usage data in the first database 140 that prevents the computing system 135 from accessing all of the usage data for the period of time. As a result, usage values for certain time intervals may be missing from the retrieved usage data (e.g., the usage data in the second database 142 may be incomplete). In these cases, the computing system 135 may normalize the usage data for the groups to correct for the missing usage data, as discussed further below.

In one embodiment, the computing system 135 may generate a HUP notification for a utility customer by retrieving usage data from the second database 142 for the customer covering a certain period of time. The period of time may cover the past N days, where N may be an integer. For instance, N may be 15 days or less. In another example, the period of time may be a completed portion of the billing period. The period of time is the period of time covered by the HUP notification.

After retrieving the usage data, the computing system 135 may group each of the corresponding usage values into one of a plurality of groups. Each group corresponds to a different time period, where each time period may be a different time-of-day period (e.g., 12 pm to 6 pm), as discussed above. After grouping the usage values into the different groups, the computing system 135 may compute usage data coverage for each group. The usage data coverage for a group may be represented as a percentage, in which a percentage of 100% indicates no missing usage values for the group and a percentage of less than 100% indicates missing usage values for the group with a lower percentage corresponding to a larger number missing usage values. A method for computing usage data coverage for a group will now be discussed according to an embodiment.

In this embodiment, the computing system 135 may compute an amount of time covered by the group. The amount of time covered by the group may be approximately equal to the amount of time spanned by the corresponding time period multiplied by the number of days covered by the HUP notification. Using the example in FIG. 3, each time period spans six hours of a day. In this example, the amount of time covered by a group equals six hours multiplied by the number of days (e.g., seven days) covered by the HUP notification. The computing system 135 may also compute an amount of time covered by the usage values in the group. The amount of time covered by the usage values in the group may be approximately equal to the number of usage values in the group multiplied by the amount of time of each usage value. For the example in which each usage value corresponds to a time interval of 15 minutes, the amount of time covered by the usage values may be equal to the number of usage values multiplied by 15 minutes. The computing system 135 may then compute the usage data coverage for the group based on a ratio of the amount of time covered by the usage values in the group to the amount of time covered by the group. The computing system 135 may compute the coverage for each of the groups by repeating the above steps for each group.

After computing the coverage for each group, the computing system 135 may compare the computed coverage for each group to a coverage threshold (e.g., 75%). If the computed coverage for at least one of the groups is below the threshold, then the computing system 135 may determine that there is insufficient usage data to generate the HUP notification, in which case the HUP notification is not generated. Otherwise, the computing system 135 may proceed with generating the HUP notification, as discussed further below. The coverage threshold may be set to a default value or set by the corresponding customer.

The computing system 135 may then compute usage for each group. For each group having coverage of 100% (no missing usage values), the computing system 135 may compute the usage for the group by summing the usage values in the group. For each group having coverage of less than 100%, the computing system 135 may compute the usage for the group using a normalization process, in which the sum of the usage values in the group is multiplied by the inverse of the computed coverage for the group. For example, the inverse of a computed coverage of 80% is approximately equal to 1.25 (i.e., 100/80). In this example, the usage is normalized by multiplying the sum of the usage values by 1.25. The normalization process corrects the computed usage for the group by accounting for missing usage values.

After computing the usage for each group, the computing system 135 may sum the usage for each group to obtain a total usage for all of the groups. For each group, the computing system 135 may then compute a percentage of the total usage contributed by the group based on the computed usage for the group and the computed total usage. The computed percentage for each group (and hence each time period) may be displayed in the HUP notification, an example of which is shown in FIG. 3. The computing system 135 may also identify the group (time period) with the largest computed usage, and highlight the identified group (time period) in the HUP notification.

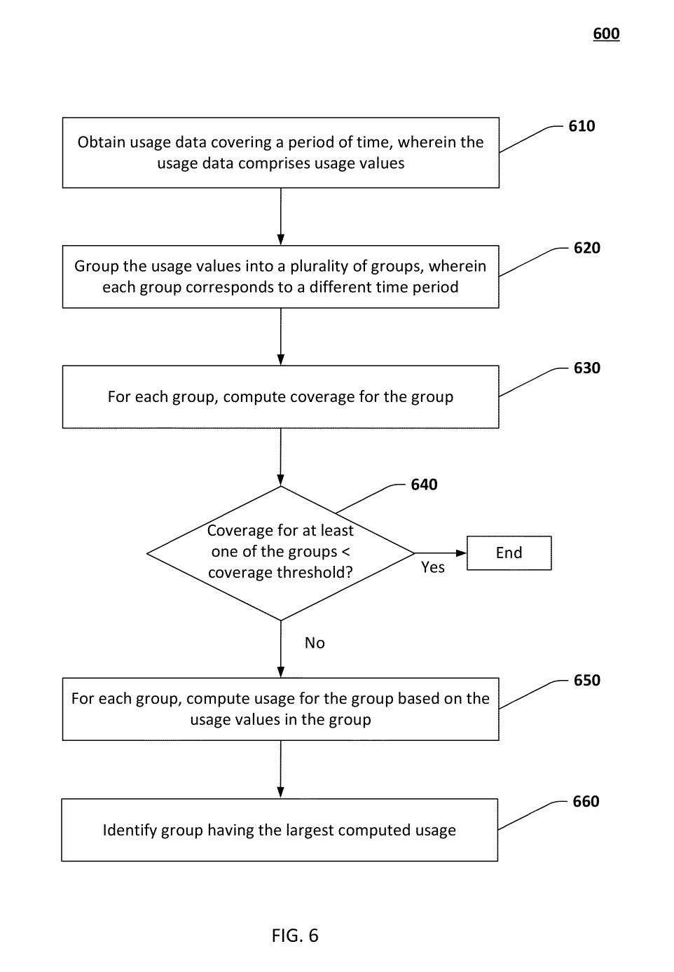

FIG. 6 is a flowchart illustrating a method 600 for processing usage data according to certain embodiments of the subject technology. The method 600 may be performed by the computing system 135. The method 600 is provided merely as an example and additional or fewer steps may be performed in similar or alternative orders, or in parallel.

In step 610, usage data covering a period of time is obtained. The usage data may comprise usage values, where each usage value corresponds to an amount of the commodity used (consumed) over a short time interval (e.g., interval of an hour or less). The period of time may cover the past N days, where N may be an integer. In another example, the period of time may be a completed portion of the current billing period.

In step 620, the usage values are grouped into a plurality of groups, wherein each group corresponds to a different time period. For example, each time period may correspond to different a time-of-day period, such as different hours of the day.

In step 630, coverage is computed for each group. For example, the coverage for a group may be computed by computing an amount of time covered by the group, computing an amount of time covered by the usage values in the group, and computing a ratio of the amount of time covered by the usage values in the group to the amount of time covered by the group. In another example, coverage for a group may be computed by determining a number of usage values that should be in the group if there are no missing values. Using an example in which the time period corresponding to the group spans six hours and each usage value covers 15 minutes, the number of usage values that should be in the group equals 24 multiplied by the number of days covered by the HUP notification (e.g., completed portion of the current billing period). After computing the number of usage values that should be in the group, the coverage for the group may be computed based on a ratio of the actual number of usage values in the group to the number of usage values that should be in the group.

In step 640, a determination is made whether the coverage for at least one of the groups is below a coverage threshold. If the coverage for at least one of the groups is below the coverage threshold, then the method 600 may end. Otherwise, the method 600 may proceed to step 650.

In step 650, for each group, usage is computed for the group based on the usage values in the group. For example, if the coverage for a group is approximately 100% (i.e., no missing usage data), then the usage for the group may be computed by summing the usage values in the group. If the coverage for a group is less than 100%, then the usage for the group may be computed using a normalization process, in which the sum of the usage values in the group is multiplied by the inverse of the coverage for the group.

In step 660, the group with the highest computed usage is identified. In one aspect, the time period corresponding to the identified group may be highlighted in a HUP notification to indicate to the respective customer the time period in which he/she uses (consumes) the most resources.

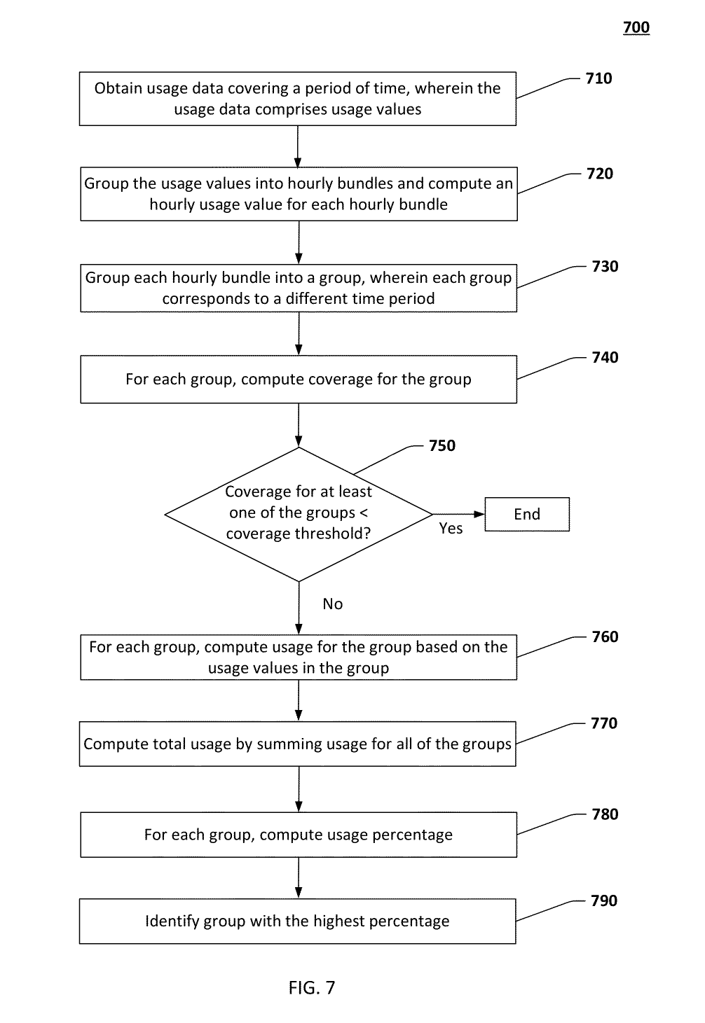

FIG. 7 is flowchart illustrating a method 700 for processing usage data according to certain embodiments of the subject technology. The method 700 may be performed by the computing system 135. The method 700 is provided merely as an example and additional or fewer steps may be performed in similar or alternative orders, or in parallel.

In step 710, usage data covering a period of time is obtained. The usage data may comprise usage values, where each usage value corresponds to an amount of the commodity used (consumed) over a short time interval (e.g., 15 minutes). The period of time may be a completed portion of the current billing period, which may begin at the start of the current billing period and end at the time of the last usage report from the corresponding monitoring device.

In step 720, the usage values are grouped into hourly bundles and an hourly usage value is computed for each hourly bundle. For example, if each usage value has a time interval of 15 minutes, then four consecutive usage values may be grouped into the same hourly bundle. The hourly usage value for each hourly bundle may be computed by summing the individual usage values in the bundle. For the example in which each hourly bundle comprises four consecutive usage values, the corresponding hourly usage value is computed by summing the four consecutive usage values.

In step 730, the hourly usage values are grouped into a plurality of groups, wherein each group corresponds to a different time period. For example, each time period may correspond to different hours of the day. Using the example in FIG. 3, an hourly usage value corresponding to a time interval of 6 am-7 am would be group into time period 315a (ham-12 pm period).

In step 740, coverage is computed for each group. For example, the coverage for a group may be computed by computing a number of hours covered by the group, and dividing the number of hourly usage values in the group by the number of hours covered by the group. The number of hours covered by the group may be computed by multiplying the number of hours in the corresponding time period (e.g., 12 pm-6 pm period) by the number of days covered by the period of time (e.g., completed portion of the current billing period).

In step 750, a determination is made whether the coverage for at least one of the groups is below a coverage threshold. This may be done by comparing the coverage for each group with the threshold. The coverage threshold may be configurable by the respective customer with a default set to a predetermined threshold (e.g., 75%). If the coverage for at least one of the groups is below the coverage threshold, then the method 700 may end, in which case a corresponding HUP notification is not generated. Otherwise, the method 700 may proceed to step 760.

In step 760, for each group, usage is computed for the group based on the usage values in the group. For example, if the coverage for a group is approximately 100% (i.e., no missing usage data), then the usage for the group may be computed by summing the hourly usage values in the group. If the coverage for a group is less than 100%, then the usage for the group may be computed using a normalization process, in which the sum of the hourly usage values in the group is multiplied by the inverse of the coverage for the group. For example, if the sum of the hourly usage values for a group is 1,300 kWh and the coverage for the group is 75%, then 1,300 kWh is multiplied by (100/75) to obtain a normalized usage of 1,733.33 kWh.

In step 770, total usage is computed by summing the usage for all of the groups.

In step 780, a usage percentage is computed for each group. For example, the usage percentage for a group may be computed by dividing the computed usage for the group by the total usage. The usage percentage for each group (and hence each time period) may be displayed in the HUP notification, an example of which is shown in FIG. 3.

In step 790, the group with the highest usage percentage is identified. In one aspect, the time period corresponding to the identified group may be highlighted in a HUP notification to indicate to the respective customer the time period in which he/she uses (consumes) the most resources.

It is to be appreciated that usage for a particular time period may be expressed using a ratio instead of a percentage. For example, a percentage usage of 20% may be expressed as a ratio of 1/5. Further, it is to be appreciated that the usage information for the time periods in a HUP notification may be presented using different formats, and is therefore not limited to the exemplary format shown in FIG. 3. For example, the usage information for the time periods may be presented in a pie chart, in which each time period corresponds to a sector in the pie chart. In this example, the size of each sector may be proportional to the usage percentage or ratio for the corresponding time period.

Further, it is to be appreciated that usage values may be group into a plurality of groups in sub-steps. For example, each group may be further divided into a plurality of subgroups. In this example, each usage value may first be grouped into one of the subgroups of the groups. The usage values in each subgroup may then be group into the corresponding group. Accordingly, it is to be appreciated that grouping usage values into a plurality of groups may involve subgrouping. It is also to be appreciated that the usage values for a group may be summed in sub-steps. For example, the usage values in each subgroup of a group may be summed, and the resulting sums for the subgroups may be summed to obtain the sum for the group.

It is to be appreciated that a HUP notification may divide the time of day into any number of time periods (blocks), and is therefore not limited to the example of four shown in FIG. 3. Further, the time periods may have different lengths, and is therefore not limited to the example in FIG. 3, in which each time period has the same length of six hours.

As discussed above, a high-bill alert notification may be sent to a customer before the end of the current billing period if the customer is on track to receive a high bill. In this regard, the computing system 135 may determine whether a customer is on track to receive a high bill before the end of the current billing period. For example, the high-bill alert notification may be sent when 50% or more of the current billing period still remains. To determine whether to send a high-bill alert, the computing system 135 may forecast (projects) the customer's utility bill for the current billing period based on the amount of the commodity already used (consumed) by the customer in the current billing period (amount used in the completed portion of the current billing period), and a projection of the amount of the commodity that the customer will use (consume) in the remaining portion of the current billing period.

In one embodiment, the computing system 135 may compute the forecasted (projected) bill for the end of the current billing period as follows:

Fc=Cc+cost_rate·remaining_time (1)

where Fc is the forecasted cost at the end of the current billing period, Cc is the cost for the completed portion of the current billing period (i.e., cost for the amount of the commodity already used by the customer during the current billing period), cost_rate is a cost rate, and remaining_time is the time remaining in the current billing period. The cost rate may be computed by dividing the actual cost over a time window (e.g., cost for the amount of the commodity used (consumed) over the time window) by the amount of time in the time window. Thus, in this example, the cost rate may be an average cost rate over the time window. The customer's projected usage may also be calculated in a similar manner. For example, a rate of use may be computed by dividing the customer's actual usage over the time window by the amount of time in the time window. The projected usage for the remaining portion of the billing period may then be computed by multiplying the rate of use with the time remaining in the billing period. The projected usage for the entire billing period may be computed by adding the projected usage for the remaining portion of the billing period with the usage in the completed portion of the billing period. In this example, the projected cost for the billing period may be computed by applying the appropriate utility rates to the projected usage.

In one example, the time window may be a trailing time window covering the past N days, where N is an integer. In this example, seven may be used for N because the customer's usage may be different for different days of a week, and seven days may reflect both low and high usage during the week. Other values may also be used for N. For example, N may be 15 days or less. It is be appreciated that a customer's bill may be forecasted using other methods, and therefore that embodiments of the subject technology are not limited to the exemplary method discussed above. For example, usage may be forecasted using a weather forecast from a weather service to take into account weather on future use (consumption).

The computing system 135 may then compare the forecasted bill to a threshold. The threshold may be set to an amount equal to a certain percentage (e.g., 30%) above a previous utility bill of the customer, or other amount. For example, if the threshold is 30% above the previous bill (i.e., threshold is above 130% of the previous bill), then the threshold may be equal to the previous bill multiplied by 1.3. The previous bill may correspond to the same billing period in the previous year as the current billing period. In another example, the previous bill may be the bill for the billing period immediately preceding the current billing period. The percentage above the previous bill may be equal to a default value (e.g., 30%) or a value that is set by the respective customer. In another example, the threshold may be equal to a default dollar amount or a predetermined dollar amount set by the respective client. For embodiments in which the threshold is configured by the respective customer, the computing system 135 may support a website that the customer may access, for example, via a web browser on the respective computing device 150a-150c. In this example, the customer may access the website to manage his/her utility account, including setting the threshold for triggering a high-bill alert.

If the forecasted (projected) bill is above the threshold, then the computing system 135 may send a high-bill alert notification to the customer via electronic mail, text message, automated call, etc. Alternatively, the computing system 135 may send the high-bill alert notification to the utility server 132 to send to the customer. Thus, in this example, the triggering condition for a high-bill alert notification is the forecasted bill exceeding the threshold. The high-bill alert notification may include a HUP notification. The HUP notification may be included automatically with the high-bill alert notification. In another example, the HUP notification may be included with the high-bill alert when a second-trigger condition is met, as discussed further below.

In one embodiment, the computing system 135 may compute usage for a customer over a period of time, and compare the computed usage to a usage threshold. If the computed usage is above the usage threshold, then the computing system 135 may determine to include a HUP notification with the high-bill alert notification. The usage may be computed by summing the usage values (usage readings) over the period of time. If some usage data is missing within the period of time, then the computing system 135 may normalize the usage to account for the missing data using any of the techniques discussed above. Thus, in this embodiment, a high-bill alert with a HUP notification is sent if both the trigger condition for the high-bill alert is met, and the trigger condition for the HUP notification is met. This may be done, for example, so that the HUP notification is not sent when a large increase in the customer's bill is due primarily to other factors besides a large increase in usage, such as a large increase in utility rates.

In one example, the usage threshold may be set to a certain percentage (e.g., 30%) above the customer's usage over the same period of time in the previous year. In another example, the computing system 135 may compute usages for a plurality of other customers (e.g., similar customers) over the same period of time, compute an average of the usages for the other customers to obtain an average usage, and set the threshold to a certain percentage above the average usage. In both examples, the percentage may be a default percentage (e.g., 30%) or a percentage that is set by the respective customer. The customer may set the percentage, for example, by accessing a website for managing his/her utility account, as discussed above. In yet another example, the usage threshold may be set to a predetermined value or a value set by the respective customer.

It is to be appreciated that the subject technology is not limited to sending a HUP notification with a high-bill alert notification. In other words, a HUP notification does not need to be tied to a high-bill alert notification. For example, a HUP notification may be sent to the respective customer when the trigger condition for sending a HUP notification is met regardless of whether the trigger condition for sending a high-bill alert is met. In this case, the HUP notification may give the customer insight into what is driving high usage. In one example, a HUP notification may be generated for an entire billing period and provided to the customer along with a home energy report or billing statement. In this example, the computing system 135 may compute the HUP notification based on usage data for an entire billing period and send the HUP notification to the utility server 132 in a home energy report or billing statement. In this case, the HUP notification may provide the customer with insight into how to reduce energy consumption for the next billing period (cycle).

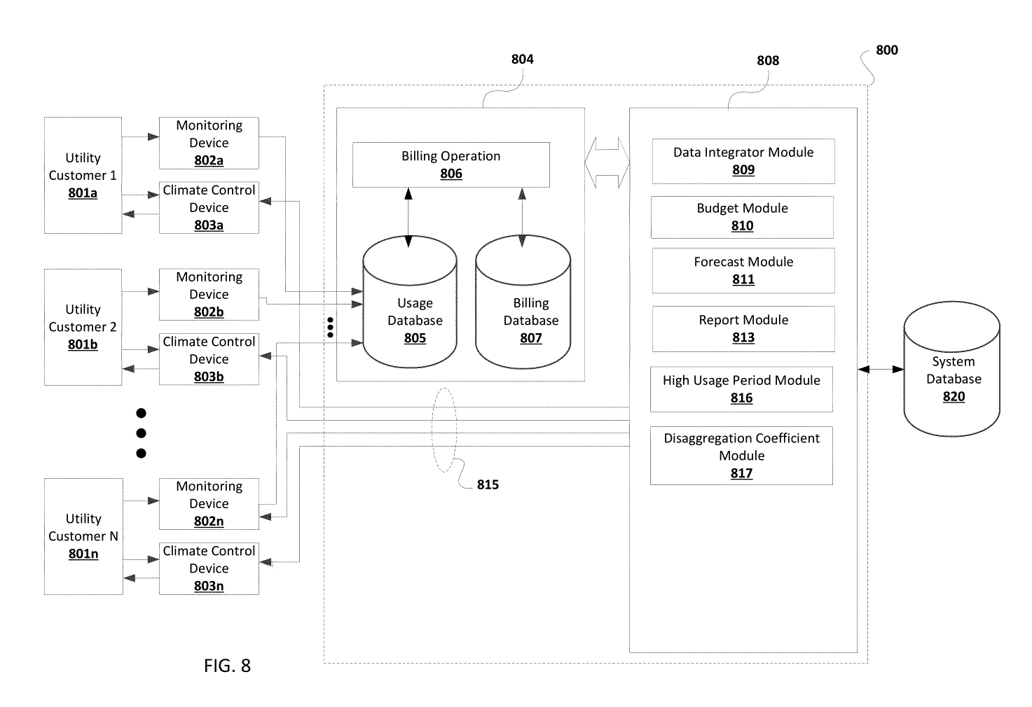

FIG. 8 illustrates an example of a system 800 according to certain aspects of the subject technology. The system 800 includes a utility management system 804 and a usage notification system 808. The utility management system 804 is coupled to utility customers 801a-801n via monitoring devices 802a-802n and climate control devices 803a-803n. The utility management system 804 includes a usage database 805, a billing operation module 806, and billing information database 807. The usage notification system 808 includes a data integrator module 809, a budget module 810, a forecast module 811, a report module 813, a high usage period module 816, a disaggregation coefficient module 817, and a system database 820. The usage notification system 808 may convey information targeted to one or more of the utility customers 801a-801n over communication channels 815. The utility management system 804 and notification system 808 may correspond to the utility server 132 and computing system 135, respectively, in FIG. 1. The usage and billing information databases 805 and 807 may correspond to the first database 140 in FIG. 1, and the system database 820 may correspond to the second database in FIG. 1.

The utility management system 804 stores usage data in the usage database 805. The usage data is associated with one or more commodities consumed by the utility customers 801a-801n. The usage data may include usage information corresponding to usage of at least one of the one or more commodities for multiple utility customers (e.g., utility customers 801a-801n). The usage information may include past usage information of the commodity during at least one of completed billing period and a current usage of the at least one of the one or more commodities during a completed portion of a current billing period. The usage data for a utility customer may be obtained from a corresponding monitoring device 802a-802n (e.g., smart meter) on a scheduled basis, periodic basis or a non-scheduled basis. The monitoring devices may relate to an advanced metering infrastructure (AMI). In this respect, the monitoring devices may be smart meters or, at least in part, include smart meter functionality for measuring electrical, water and/or natural gas consumption in the property associated with the corresponding utility customer. For example, the usage data may consist of usage information corresponding to the property in its entirety such that usage information relating to one or more components in the property is disaggregated by the utility management system 804 and/or the billing management system 808. The term “component of a property” refers to a component (e.g., heating, ventilation and air conditioning (HVAC) system) associated with the property that is able to consume a commodity. In an aspect, the utility management system 804 stores and forwards the usage data to the usage notification system 808 for usage notification processing. The utility management system 804 described herein may refer to a utility company or an offsite third party service provider that is interfaced with the utility company.

The billing operation module 806 may be configured to generate billing statements (utility bills) for utility customers at the end of a billing period. To generate a billing statement for a customer, the billing operation module 806 may retrieve usage data for the customer covering the current billing period from the usage data database 805, retrieve utility rates from the billing information database 807, and apply the utility rates to the usage data to generate the billing statement. The billing operation module 806 may then send the billing statement to the respective customer (e.g., via electronic mail, text message, hard copy, etc.). The billing operation module 806 may also store the billing statement in the billing information database 807.

The data integrator module 809 retrieves data that the usage notification system 808 needs from the usage data database 805 and the billing information database 807, and stores the retrieved data in the system database 820. The data may include usage data, previous utility bills, utility rates (e.g., rate schedule), customer contact information, etc. It is to be appreciated that the data integrator module 818 may import data from other databases besides databases 805 and 807. For example, the integrator module 818 may import weather data from a database operated by the weather service provider in the example where projected usage takes into account weather forecasts. In general, the data integrator module 818 may retrieve data that the usage notification system 808 needs from multiple databases and store the data in the system database 820 (e.g., consolidate the data in the database 820) for use by the modules 809-817 in the usage notification system 808.

The budget module 810 may determine a target budget for the current billing period based on the usage data, utility bills for previous billing periods, etc. In an aspect, the budget module 810 may include a budget advisor, which is an automated system for at least determining one or more candidate budget targets. In one aspect, the target budget may include a threshold cost that is used to trigger a high-bill alert notification when a forecasted (projected) cost for the current billing period exceeds the threshold. The threshold may be generated using any of the methods discussed above. The target budget may be stored in the system database 820 for use by other modules. The forecast module 811 may be configured to forecast (project) energy use by the utility customers 801a-801n based on the corresponding usage data. The forecast module 811 may also be configured to forecast (project) utility bills for utility customers 801a-801n before the end of the current billing period. The forecast module 811 may include an algorithm used to determine projected usage and/or a projected utility bill using rate of use information and billing period information. The rate of use may be based on the amount of energy consumed over a specified number of days, for example. The rate of use may be applied to the remaining amount of time in the current billing period to forecast usage for the remaining portion of the billing period, as discussed above. The forecasted usage and/or forecasted utility bill may be stored in the system database 820 for use by other modules.

The report module 813 may be configured to generate a usage alert notification, and cause the usage alert notification to be sent to one or more of the utility customers 801a-801n based on one or more reporting conditions (e.g., projected bill exceeding target budget, current billing period ended, utility customer inquiry, etc.) through the communication channels 815. For example, the report module 813 may generate the usage alert notification when the forecasted utility bill for a customer exceeds the threshold cost for the customer, as discussed above.

The communication channels 815 may carry alert notifications to the utility customers 801a-801n over a wired and/or a wireless communication. In an aspect, the usage notification system 808 sends the alert notifications in a broadcast and/or multicast signal to the utility customers 801a-801n via the climate control devices 803a-803n. The usage notification system 808 may specifically target one or more of the utility customers 801a-801n, and send a personalized alert notification over a unicast signal. The communication channels 815 may be configured to interface to a smart meter (e.g., the monitoring devices 802a-802n), a thermostat (e.g., the climate control device 803a-803n), a customer's mobile device, a data exchange interface of a cellular network, and other networks.

The high usage period module 816 shows the customer how much energy they use at each period during the day and highlights the highest period. For example, the high usage period module 816 may generate a HUP notification for one of the utility customers based on usage information for the customer according to any of the embodiments discussed above. The usage information may be obtained from the system database 820, which may have been imported to system database 820 from the usage database 805. The high usage period module 816 may then forward the generated HUP notification to the report module 812 to be included an energy usage alert notification for the customer. The HUP notification may be included with the usage alert notification to provide the customer with insight into what is driving high usage, as discussed above. The report module 812 may then send the energy usage alert notification with the HUP notification to the customer's climate control device or other device (e.g., customer's mobile device) via communication channel 815.

The disaggregation coefficient module 817 is discussed in further detail in U.S. Pat. No. 8,660,813, entitled “Method and System for Disaggregating Heating and Cooling Energy Use from Other Building Energy Use,” filed Nov. 5, 2010, of which is hereby incorporated by reference in its entirety.

In operation, the system 800 allows for a target budget to be set for each of the utility customers 801a-801n, a projected use to be calculated for the utility customer 801a-801n based on the retrieved usage data for that utility customer, and a budgeting communication to be transmitted to a climate control device 803a-803n (e.g., a thermostat) or other device (e.g., mobile device) of that utility customer if the projected use is determined to be greater than the target budget. In certain implementations, the budgeting communication may cause the thermostat to alert the utility customer that the utility customer's resource usage is projected to exceed the targeted budget, provide recommendations on how to meet the targeted budget, and/or automatically adjust thermostat settings to meet the targeted budget.

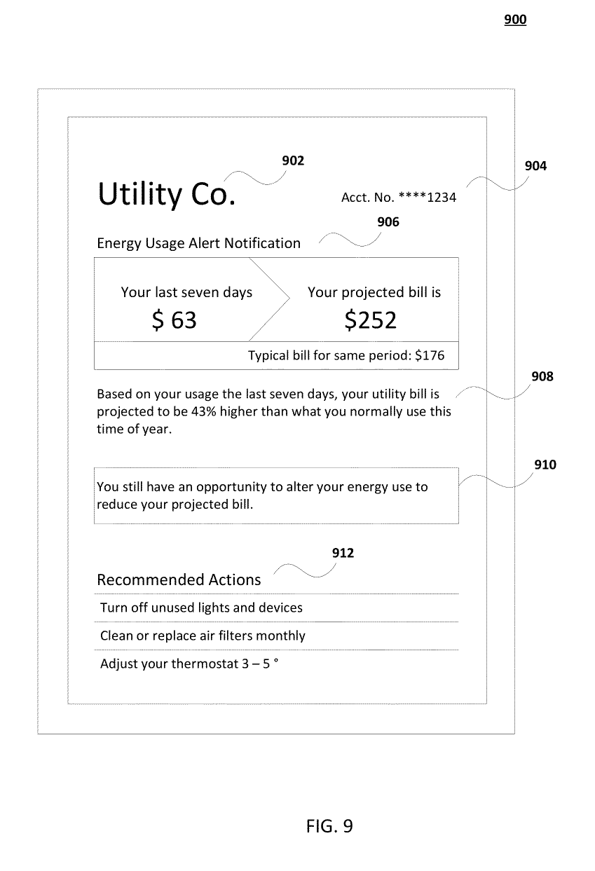

FIG. 9 illustrates an example of a high-bill alert notification 900 according to certain aspects of the subject technology. The high-bill alert notification 900 may also be referred to as an energy usage alert notification. The alert notification 900 is similar to the one shown in FIG. 2 and includes additional information, as discussed further below.

The alert notification 900 includes a utility identifier 902, an account number 904, an alert title 906, a report analysis 908, a report message 910, and a recommendation portion 912. The alert notification 900 is provided merely as an example and additional or fewer features may be included in similar or alternative formats within the scope of the various embodiments described in this specification.

The utility identifier 902 may relate to the utility company associated with the generation of the alert notification 900. The utility identifier 902 may include a name of the utility company, an address for the utility company, and/or contact information for the utility company.

The account number 904 may relate to the corresponding utility customer subscribed to receive energy usage alerts such as the alert notification 900. For privacy reasons, the account number 904 may be limited to a subset of numbers that, at least in part, identify the utility account. In an aspect, the account number 904 is displayed in its entirety.

The alert title 906 provides an identification of the type of notification contained in the alert notification 900. For example, the alert title 906 may relate to a power conservation alert where the notification 900 provides the utility customer an indication on how to save energy and/or money for the current billing period. In this respect, the alert notification 900 may be sent to the utility customer before the end of the current billing period to allow the utility customer sufficient time to make certain adjustments to current climate control settings of the corresponding property.

The report analysis 908 may include information relating to how the current projected bill compares to prior utility bills, and may include a metric to give the utility customer some context to the current projected bill. The report analysis 908 may include additional metrics such as a chart to provide the utility customer a visual analysis of the current projected bill.

The report message 910 may include an indication to the utility customer that the projected bill can still be altered if certain adjustments can be made prior to the end of the current billing period. The report message 910 also may include other report messages relating to the current projected bill such as usage information relating to specific components of the property and/or rate information over the duration of the current billing period.

The recommendation portion 912 may include recommendations on how to modify usage so that actual usage can remain within the budgeted use for the specified budget period. The recommendations may include set points or set point schedules that may be used on the climate control device, suggestion to turn off light sources and/or electronic devices, maintenance suggestions, and specific adjustments to the climate control device.

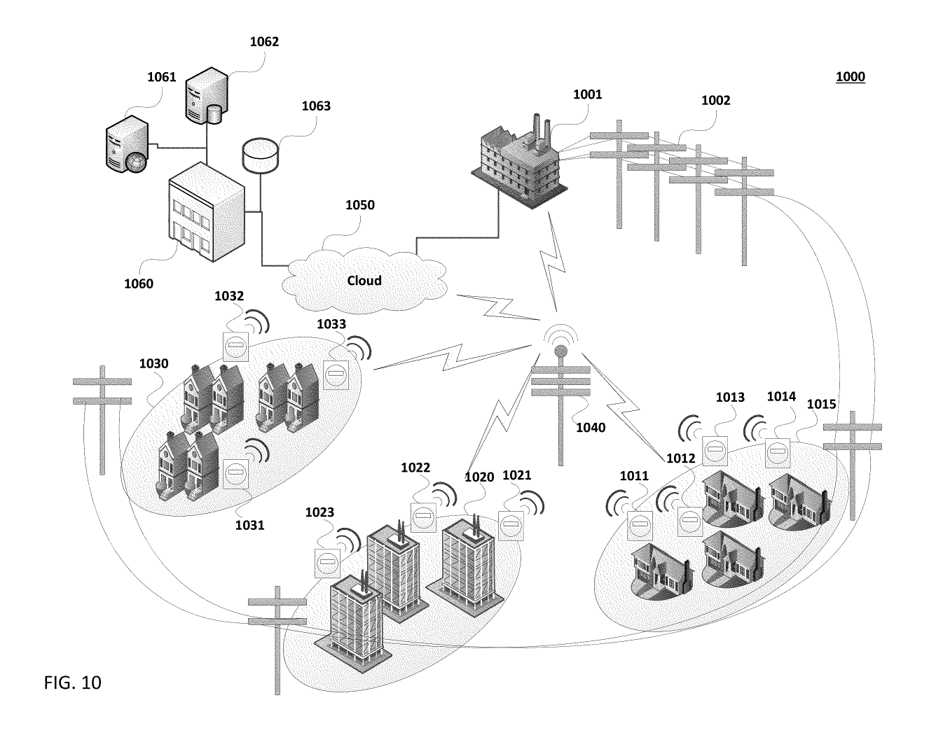

FIG. 10 illustrates an example of an environment 1000 for implementing aspects of the subject technology in accordance with various embodiments. The environment 1000 includes a utility company 1001, power distribution system 1002, utility customer regions 1010, 1020 and 1030, energy usage collector 1040, a network 1050 and a usage alert system 1060. The utility customer region 1010 includes residential structures with corresponding smart meters 1011-1014. The utility customer region 1020 includes commercial structures with corresponding smart meters 1021-1023. The utility customer region 1030 includes multi-family structures with corresponding smart meters 1031-1033. The usage alert system 1060 includes a web server 1061, an application server 1062 and a database 1063.

The utility company 1001 provides a commodity (e.g., electricity, gas, water) to the utility customer regions 1010, 1020 and 1030. The utility company 1001 may track the energy usage from each region via a monitoring device (e.g., a smart meter) associated with each structure of the corresponding region. The utility company 1001 may receive usage data that includes the amount of energy consumption (e.g., kWh) for the corresponding utility account. In an aspect, the utility company 1001 receives the usage data from the energy usage collector 1040 via a wireless communication system. In some aspects, the energy usage collector 1040 may obtain the usage data by pulling the usage data from each of the smart meter devices. The smart meter devices may broadcast usage data on a periodic or scheduled basis. The utility company 1001 also may receive the usage data from each monitoring device through a wired communication system.

The usage alert system 1060 is in communication with the utility company 1001 via the network 1050. The usage alert system 1060 may obtain the usage data from the utility company 1001 via the network 1050. In an aspect, the usage alert system 1060 receives the usage data via the network 1050. The usage alert system 1060 may receive the usage data directly from the smart meter devices.

Each of the utility customer regions 1010, 1020 and 1030 may correspond to a separate geographical location with a respective rate schedule. In some aspects, an energy usage alert notification for a corresponding utility customer in one region may be generated using usage data of similar users in the same region to provide the corresponding utility customer with a comparative analysis of its energy consumption (e.g., current energy usage compared to similar customers in the same zip code or within a certain radius).

The usage alert system 1060 also may be in communication with a third party weather service, such as the National Weather Service (not shown). For example, the usage alert system 1060 may receive corresponding outdoor temperatures from the third party weather service via the network 1050 (e.g., e-mails, downloaded FTP files, and XML feeds). In this respect, the usage alert system 1060 may use data from the third party weather service to determine a projected use for a current billing period. For example, forecasted weather conditions (e.g., the temperature, the humidity, the barometric pressure, precipitation, etc.) may indicate that the utility customer's HVAC system is likely to be in greater use. The usage alert system 1060 may estimate the projected use for the remaining amount of time of the current billing period, and thereby determine if the utility customer is on pace to exceed the projected bill based on the estimated projected use. In turn, the usage alert system 1060 may notify the utility customer through an energy usage alert notification. The usage alert system 1060 may also generate a HUP notification, and include the HUP notification with the energy usage alert notification according to any of the embodiments described herein.

The usage alert system 1060 communicates the energy usage alert notification to utility customers associated with the utility customer regions 1010, 1020 and 1030. In some aspects, the usage alert system 1060 communicates the energy usage alert notification via the network 1050. For example, the usage alert system 1060 may send the energy usage alert notification in an e-mail or the utility customer may log into the usage alert system 1060 (e.g., the web server 1061 and/or application server 1062) through an associated website to view the disaggregated usage data included in the energy usage alert notification. The usage alert system 1060 may send the energy usage information to a printing system so that the energy usage alert notification can be provided to the utility customer via regular mail (e.g., as part of a utility bill). In other embodiments, the energy usage information is communicated back to the utility company 1001 such that the utility company 1001 can provide the energy usage alert notification to the utility customer.

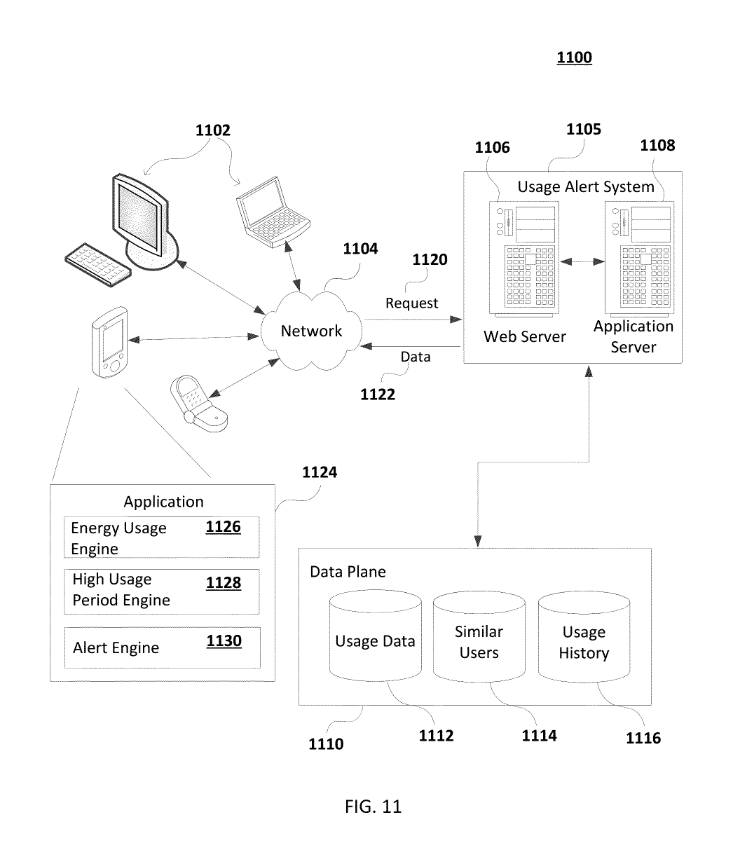

FIG. 11 illustrates an example of a system 1100 for energy usage alert according to certain aspects of the subject technology. Although a web-based environment is described for purposes of explanation, different environments may be used, as appropriate, to implement various embodiments.

The example system 1100 includes a usage alert system 1105 and a data plane 1110. The usage alert system 1105 includes at least one web server 1106 and at least one application server 1108, as described below. The usage alert system 1105 is an example of an energy usage notification system implemented as computer programs on one or more computers in one or more locations, in which the systems, components, and techniques described below can be implemented.

A user can interact with the usage alert system 1105 through a client device 1102. For example, the client device 1102 can be a computer coupled to the usage alert system 1105 through a data communication network 1104 (e.g., the Internet). In some instances, the usage alert system 1105 can be implemented on the client device 1102, for example, through a software application executing on the client device 1102. The client device 1102 generally includes a memory, for example, a random access memory (RAM), for storing instructions and data, and a processor for executing stored instructions. The client device 1102 can be any appropriate device operable to send and receive requests, messages, or other types of information over the data communication network 1104. The client device 1102 can also include a display screen though which the user interacting with the client device 1102 can view information, for example, the alert notification in FIG. 2, 3 or 9. Some examples of client devices include personal computers, smart thermostats, cellular phones, handheld messaging devices, laptop computers, set-top boxes, personal data assistants, electronic book readers, tablet devices, smartphones and the like.

The data communication network 1104 can include any appropriate network, including an intranet, the Internet, a cellular network, a local area network, a wide area network, or any other such network, or combination thereof. Components used for such a system can depend at least in part upon the type of network, the environment selected, or both. Protocols and components for communicating over such a network are well known and will not be discussed herein in detail. The client device 1102 can communicate over the data communication network 1104 using wired or wireless connections, and combinations thereof.

A user can use the client device 1102 to submit a request 1120 to log into the usage alert system 1105. The request 1120 can request a digital copy of an energy usage alert notification for a corresponding utility account. The energy usage alert notification may include information relating to how much energy has been consumed to date and/or a projected bill amount for a current billing period. The usage alert notification may also include information relating to one or more recommendations for adjusting settings in the property associated with the corresponding utility account such that the projected bill is kept below a target budget for the current billing period. When the user submits the request 1120, the request 1120 may be transmitted through the data communication network 1104 to the application server 1108 within the usage alert system 1105. The application server 1108 responds to the request 1120 by using, for example, usage data 1112, to identify data 1122 describing an energy usage alert with personalized information in response to the request 1120. The application server 1108 sends the data 1122 through the data communication network 1104 to the client device 1102 for presentation to the user.

The data 1122 can include data describing a projected bill for a current billing period. The data 1122 can be used, for example, by the client device 1102, to generate a local energy usage alert notification with one or more interactive features such as energy consumption adjustments with corresponding utility bill projections and/or instructions for adjusting settings on a climate control device associated with the corresponding utility customer.

After receiving the data 1122 from the application server 1108, and through the data communication network 1104, a software application, for example, web browser or application 1124, running on the client device 1102 renders an interactive energy usage alert notification using the data 1122. For example, an energy usage engine 1126 in the application 1124 can describe the usage to date including a projected use for the current billing period, for display on a display screen of the client device 1102.

In some aspects, the application 1124 includes a high usage period engine 1128 that is configured to render an interface on the client device 1102, and perform one or more actions related to the instructions for showing specific periods of high usage. In some embodiments, the high usage period engine 1128 is configured to obtain data relating to current settings of the client device 1102. The high usage period engine 1128 may normalize usage data values over a specified time period to accommodate for missing usage data values. The high usage period engine 1128 may also identify a highest usage period for a customer based on usage data, generate a HUP notification identifying the highest usage period, and forward the HUP notification to the energy usage alert engine 1126 for inclusion in an energy usage alert notification. In an aspect, the application 1124 includes an alert engine 1130 that is configured to render the energy usage alert notification including allowing the user to set (or program) rules and/or conditions for receiving the energy usage alert notification.

In some embodiments, the web server 1106, the application server 1108, and similar components, can be considered to be part of the data plane 1110. The handling of all requests and responses, as well as the delivery of content between the client device 1102 and the application server 1108, can be handled by the web server 1106. The web server 1106 and the application server 1108 are merely example components. However, more or fewer components can be used as structured code can be executed on any appropriate device or host machine as discussed elsewhere herein.

The data plane 1110 includes one or more resources, servers, hosts, instances, routers, switches, data stores, other similar components, or a combination thereof. The resources of the data plane 610 are not limited to storing and providing access to data. Indeed, there may be several servers, layers, or other elements, processes, or components, which may be chained or otherwise configured, and which can interact to perform tasks including, for example, obtaining data from an appropriate data store. In some embodiments, the term “data store” refers to any device or combination of devices capable of storing, accessing, and retrieving data, which may include any combination and number of data servers, databases, data storage devices, and data storage media, in any standard, distributed, or clustered environment.

The data stores of the data plane 1110 can include several separate data tables, databases, or other data storage mechanisms and media for storing data relating to a particular aspect. For example, the data plane 1110 illustrated includes mechanisms for storing usage data 1112 and user information 1116, which can be used to generate the energy usage alert notification. The data plane 1110 is also shown to include a mechanism for storing similar user data 1114, which can be used for purposes such as reporting a comparative analysis of the usage data for the corresponding utility customer. The data plane 1110 is operable, through logic associated therewith, to receive instructions from the application server 1108 and to obtain, update, or otherwise process data, instructions, or other such information in response thereto, as described above.

Each server typically includes an operating system that provides executable program instructions for the general administration and operation of that server, and typically will include a computer-readable medium storing instructions that, when executed by a processor of the server, enable the server to perform its intended functions. Suitable implementations for the operating system and general functionality of the servers are known or commercially available, and are readily implemented by persons having ordinary skill in the art, particularly in light of the disclosure herein.

The environment in one embodiment is a distributed computing environment including several computer systems and components that are interconnected through one or more communication links, using one or more computer networks or direct connections. However, the system described above can be configured to operate equally well using fewer or a greater number of components than are illustrated in FIG. 11. Thus, the system 1100 in FIG. 11 is provided merely as one example, and does not limit the scope of the disclosure.

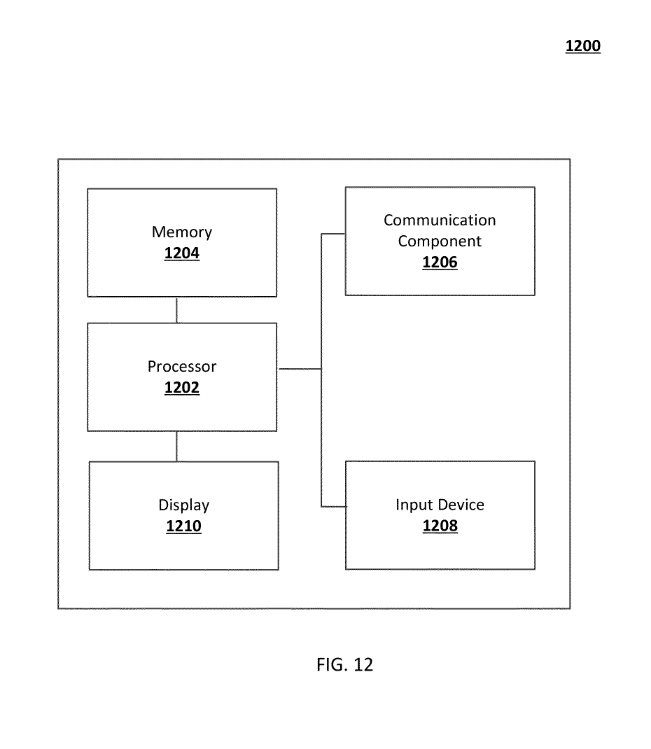

FIG. 12 illustrates an example configuration of components of a computing device 1200 according to certain aspects of the subject technology. The computing device 1200 may be used to implement one of the computing devices 150a-150c in FIG. 1, one of the climate control devices 803a-803n in FIG. 8 or any other device described herein. In this example, the computing device 1200 includes a processor 1202 for executing instructions that can be stored in a memory device or element 1204. The instructions may cause the computing device 1200 to execute a computer-implemented method for processing energy usage alerts from the energy usage alert system and/or receive instructions to automatically adjust settings (e.g., temperature settings, alarm settings, power settings) of the computing device 1200. As would be apparent to one of ordinary skill in the art, the computing device 1200 can include many types of memory, data storage, or non-transitory computer-readable storage media, such as a first data storage for program instructions for execution by the processor 1202, a separate storage for usage history or user information, a removable memory for sharing information with other devices, etc. In some embodiments, the computing device 1200 can include one or more communication components 1206, such as a Wi-Fi, Bluetooth®, radio frequency, near-field communication, wired, or wireless communication system. The computing device 1200 in many embodiments can communicate with a network, such as the Internet, and may be able to communicate with other such devices (e.g., the energy usage alert system, other climate control devices). As discussed, the computing device 1200 in many embodiments will include at least one input element 1208 able to receive conventional input from a user. This conventional input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual and audio commands, such that a user can control the device without having to be in contact with the device. The computing device 1200 includes some type of display element 1210, such as a touch screen or liquid crystal display (LCD).

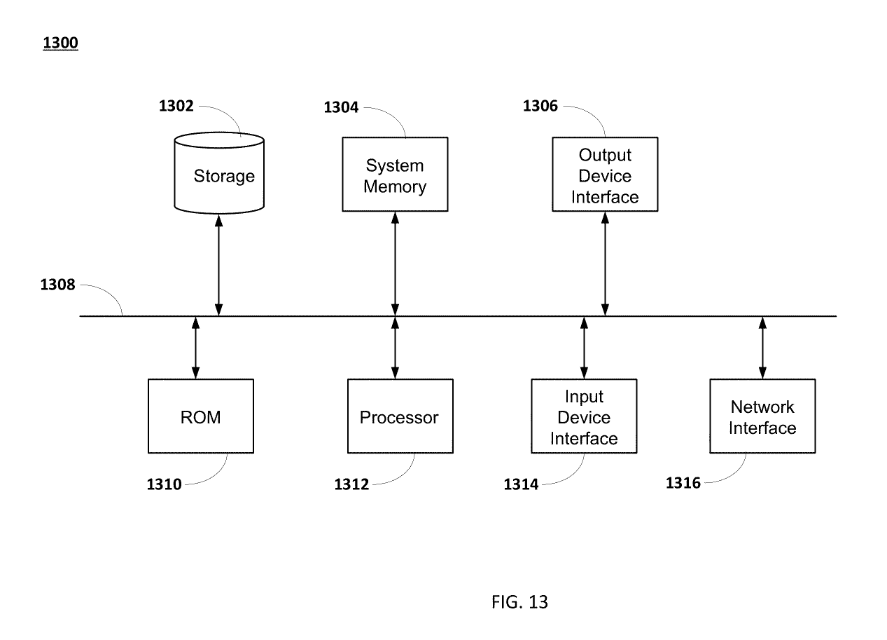

FIG. 13 illustrates an electronic system 1300 with which features of the subject technology may be implemented. For example, electronic system 1300 may be used to implement the computing system 135 in FIG. 1. Electronic system 1300 may include a bus 1308, processing unit(s) 1312, a system memory 1304, a read-only memory (ROM) 1310, a permanent storage device 1302, an input device interface 1314, an output device interface 1306, and a network interface 1316.

Bus 1308 collectively represents all system, peripheral, and chipset buses that communicatively connect the numerous internal devices of electronic system 1300. For instance, bus 1308 communicatively connects processing unit(s) 1312 with ROM 1310, system memory 1304, and permanent storage device 1302.

From these various memory units, processing unit(s) 1312 may retrieve instructions (e.g., code) to execute and data to process in order to execute processes of the subject disclosure. For example, processing unit(s) 1312 may retrieve instructions for determining usage of a commodity during different time periods, determining a time period with the highest usage, and generate a HUP highlighting the time period with the highest usage. Processing unit(s) can be a single processor or a multi-core processor in different implementations.

ROM 1310 stores static data and instructions that are needed by processing unit(s) 1312 and other modules of the electronic system. Permanent storage device 1302, on the other hand, is a read-and-write memory device. This device is a non-volatile memory unit that stores instructions and data even when electronic system 1300 is off. Some implementations of the subject disclosure use a mass-storage device (such as a magnetic or optical disk and its corresponding disk drive) as permanent storage device 1302. Other implementations use a removable storage device (such as a floppy disk, flash drive, and its corresponding disk drive) as permanent storage device 1302. Like permanent storage device 1302, system memory 1304 is a read-and-write memory device. However, unlike storage device 1302, system memory 1304 is a volatile read-and-write memory, such a random access memory. System memory 1304 stores some of the instructions and data that the processor needs at runtime. From these various memory units, processing unit(s) 1312 may retrieve instructions to execute and data to process in order to execute the processes of some implementations.

Bus 1308 also connects to input and output device interfaces 1314 and 1306. Input device interface 1314 enables a user to communicate information and select commands to the electronic system. Input devices used with input device interface 1314 include, for example, alphanumeric keyboards and pointing devices (also called “cursor control devices”). Output device interfaces 1306 enables, for example, the display of images generated by the electronic system 1300. Output devices used with output device interface 1306 may include, for example, printers and display devices, such as cathode ray tubes (CRT) or liquid crystal displays (LCD).

Finally, as shown in FIG. 13, bus 1308 also couples electronic system 1300 to a network through a network interface 1316. In this manner, the electronic system 1300 can be a part of a network of computers (such as a local area network (“LAN”), a wide area network (“WAN”), or an Intranet, or a network of networks, such as the Internet. Any or all components of electronic system 1300 can be used in conjunction with the subject disclosure. For example, the network interface 1316 may receive usage data for a utility customer from a corresponding monitoring device and/or sending an alert notification to a device of the customer (e.g., customer's mobile device). The data may be stored in the storage device 1302 and/or system memory 1304 for processing by processing units(s) 1312. Processing unit(s) 1312 may process the data according to instructions for determining usage during different time periods (e.g., different parts of the day), identify the time period with the highest usage, and generate a HUP notification identifying the time period with the highest usage.

The various embodiments described herein can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, and other devices capable of communicating via a network.

Various aspects also can be implemented as part of at least one service or Web service, such as may be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, OSI, FTP, UPnP, NFS, and CIFS. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business map servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

The description of the subject technology is provided to enable any person skilled in the art to practice the various embodiments described herein. While the subject technology has been particularly described with reference to the various figures and embodiments, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these embodiments will be readily apparent to those skilled in the art, and generic principles defined herein may be applied to other embodiments. Thus, many changes and modifications may be made to the subject technology, by one having ordinary skill in the art, without departing from the scope of the subject technology.

A reference to an element in the singular is not intended to mean “one and only one” unless specifically stated, but rather “one or more.” The term “some” refers to one or more. All structural and functional equivalents to the elements of the various embodiments described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A computer-implemented method, comprising:
obtaining usage data covering a period of time, wherein the usage data comprises a plurality of usage values, each usage value indicating an amount of a commodity consumed over a respective time interval;
grouping the usage values into a plurality of groups, wherein each group corresponds to a different time period;
for each group, computing usage for the group based on the usage values in the group; and
identifying a group from the plurality of groups having a largest computed usage.

2. The computer-implemented method of claim 1, wherein each time period corresponds to a different time-of-day period.

3. The computer-implemented method of claim 2, wherein the period of time comprises a completed portion of a current billing period.

4. The computer-implemented method of claim 3, wherein at least 50% of the current billing period still remains.

5. The computer-implemented method of claim 2, wherein the period of time comprises past N number of days from a current time, wherein N is an integer.

6. The computer-implemented method of claim 5, wherein N is between three and fifteen.

7. The computer-implemented method of claim 2, further comprising generating a high usage period (HUP) notification, the HUP notification identifying the time period corresponding to the identified group.

8. The computer-implemented method of claim 7, further comprising:
computing total usage based on a sum of the computed usage for each group; and
for each group, computing a usage percentage for the group based on the computed usage for the group and the computed total usage;
wherein the HUP notification indicates the usage percentage for each group.

9. The computer-implemented method of claim 1, further comprising, for each group, computing usage data coverage for the group.

10. The computer-implemented method of claim 9, wherein computing the usage data coverage for the group comprises:
determining an amount of time covered by the usage values in the group;
determining an amount of time covered by the group; and
determining a ratio of the amount of time covered by the usage values in the group to the amount of time covered by the group.

11. The computer-implemented method of claim 9, wherein computing the usage for each of at least one of the groups comprises multiplying a sum of the usage values in the group by an inverse of the computed coverage for the group.

12. The computer-implemented method of claim 9, further comprising:
comparing the computed coverage for each group to a coverage threshold; and
making a determination whether to send a high usage period (HUP) notification to a utility customer based on the comparison, the HUP notification identifying the time period corresponding to the identified group.

13. The computer-implemented method of claim 1, further comprising:
computing total usage based on a sum of the computed usage for each group;
comparing the computed total usage to a usage threshold; and
making a determination whether to send a high usage period (HUP) notification to a utility customer based on the comparison, the HUP notification identifying the time period corresponding to the identified group.

14. The computer-implemented method of claim 13, wherein the usage threshold is based on historical usage data for the utility customer.

15. The computer-implemented method of claim 14, wherein the usage threshold is based on a certain percentage above an amount of the commodity consumed over a second period of time, the second period of time occurring prior to the period of time covered by the obtained usage data.

16. The computer-implemented method of claim 13, wherein the usage threshold is based on usage data for a plurality of utility customers.

17. A system, comprising:
a computer processor; and
a memory storing instructions that, when executed, cause the computer processor to:
obtain usage data covering a period of time, wherein the usage data comprises a plurality of usage values, each usage value indicating an amount of a commodity consumed over a respective time interval;
group the usage values into a plurality of groups, wherein each group corresponds to a different time period;
for each group, compute usage for the group based on the usage values in the group; and
identify a group from the plurality of groups having a largest computed usage.

18. A non-transitory computer-readable medium storing instructions that, when executed by a computer processor, cause the computer processor to:
obtain usage data covering a period of time, wherein the usage data comprises a plurality of usage values, each usage value indicating an amount of a commodity consumed over a respective time interval;
group the usage values into a plurality of groups, wherein each group corresponds to a different time period;
for each group, compute usage for the group based on the usage values in the group; and
identify a group from the plurality of groups having a largest computed usage.
